(19) United States
(12) Patent Application Publication
(10) Pub. No.: US 2022/0381921 A1
(43) Pub. Date: Dec. 1, 2022

(54) SATELLITE SIGNAL MEASUREMENT IN THE PRESENCE OF INTERFERENCE

(71) Applicant: QUALCOMM Incorporated, San Diego, CA (US)

(72) Inventors: Rayman Wai PON, Cupertino, CA (US); Jordan COOKMAN, San Jose, CA (US)

(21) Appl. No.: 17/330,785

(22) Filed: May 26, 2021

(51) Int. Cl. G01S 19/25; G01S 19/21

(52) U.S. Cl. CPC G01S 19/256; G01S 19/21

(57) ABSTRACT

A method of measuring a satellite signal includes: receiving, at an apparatus, the satellite signal; determining, at the apparatus, a first code phase of the satellite signal, corresponding to a first time period, based on a first portion of the satellite signal that has a first bandwidth; determining, at the apparatus, a second code phase of the satellite signal, corresponding to a second time period, based on a second portion of the satellite signal that has a second bandwidth, where the second bandwidth is larger than the first bandwidth, and where the second time period is separate from the first time period; and determining, at the apparatus, a carrier phase of the satellite signal based on the first portion of the satellite signal and a third portion of the satellite signal that has the first bandwidth and spans the second time period.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service, a fourth-generation (4G) service (e.g., Long Term Evolution (LTE) or WiMax), a fifth-generation (5G) service, etc. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Orthogonal Frequency Division Multiple Access (OFDMA), Time Division Multiple Access (TDMA), the Global System for Mobile access (GSM) variation of TDMA, etc.

A fifth generation (5G) mobile standard calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G standard. Furthermore, signaling efficiencies should be enhanced and latency should be substantially reduced compared to current standards.

### SUMMARY

An example apparatus includes: a satellite positioning system receiver; a memory; and a processor communicatively coupled to the satellite positioning system receiver, and the memory, the processor being configured to: receive a satellite signal via the satellite positioning system receiver; determine a first code phase of the satellite signal, corresponding to a first time period, based on a first portion of the satellite signal that has a first bandwidth; determine a second code phase of the satellite signal, corresponding to a second time period, based on a second portion of the satellite signal that has a second bandwidth, where the second bandwidth is larger than the first bandwidth, and where the second time period is separate from the first time period; and determine a carrier phase of the satellite signal based on the first portion of the satellite signal and a third portion of the satellite signal that has the first bandwidth and spans the second time period.

Implementations of such an apparatus may include one or more of the following features. The apparatus includes a transmitter communicatively coupled to the processor, the processor is configured to transmit, via the transmitter, an outbound signal that induces an interference signal inside the second bandwidth of the satellite signal and outside the first bandwidth of the satellite signal, and the processor is configured to determine the first code phase, instead of determining a third code phase, based on transmission of the outbound signal corresponding to the first time period, the third code phase corresponding to the first time period and being based on the second portion of the satellite signal. The processor is configured to determine a third code phase of the satellite signal, corresponding to the first time period, based on the second portion of the satellite signal, and the processor is configured to select one of the first code phase or the third code phase, to use to determine position information, based on expected interference with the second portion of the satellite signal, or based on actual interference with the second portion of the satellite signal, or a combination thereof. The apparatus includes a transmitter communicatively coupled to the processor, and the processor is configured to: transmit, via the transmitter, an outbound signal that induces an interference signal inside the second bandwidth of the satellite signal and outside the first bandwidth of the satellite signal; and select the first code phase to use to determine the position information based on transmission of the outbound signal corresponding to the first time period and to select the third code phase to use to determine the position information otherwise. The second bandwidth includes the first bandwidth.

An example method of measuring a satellite signal includes: receiving, at an apparatus, the satellite signal; determining, at the apparatus, a first code phase of the satellite signal, corresponding to a first time period, based on a first portion of the satellite signal that has a first bandwidth; determining, at the apparatus, a second code phase of the satellite signal, corresponding to a second time period, based on a second portion of the satellite signal that has a second bandwidth, where the second bandwidth is larger than the first bandwidth, and where the second time period is separate from the first time period; and determining, at the apparatus, a carrier phase of the satellite signal based on the first portion of the satellite signal and a third portion of the satellite signal that has the first bandwidth and spans the second time period.

Implementations of such a method may include one or more of the following features. The method includes transmitting, from the apparatus, an outbound signal that induces an interference signal inside the second bandwidth of the satellite signal and outside the first bandwidth of the satellite signal, and determining the first code phase includes determining the first code phase, instead of determining a third code phase, based on transmission of the outbound signal corresponding to the first time period, the third code phase corresponding to the first time period and being based on the second portion of the satellite signal. The method includes: determining a third code phase of the satellite signal, corresponding to the first time period, based on the second portion of the satellite signal; and selecting one of the first code phase or the third code phase, to use to determine position information, based on expected interference with the second portion of the satellite signal, or based on actual interference with the second portion of the satellite signal, or a combination thereof. The method includes: transmitting, from the apparatus, an outbound signal that induces an interference signal inside the second bandwidth of the satellite signal and outside the first bandwidth of the satellite signal; and selecting the first code phase to use to determine the position information based on transmission of the outbound signal corresponding to the first time period and selecting the third code phase to use to determine the position information otherwise. The second bandwidth includes the first bandwidth.

Another example apparatus includes: means for receiving a satellite signal; means for determining a first code phase of the satellite signal, corresponding to a first time period, based on a first portion of the satellite signal that has a first bandwidth; means for determining a second code phase of the satellite signal, corresponding to a second time period, based on a second portion of the satellite signal that has a second bandwidth, where the second bandwidth is larger than the first bandwidth, and where the second time period is separate from the first time period; and means for determining a carrier phase of the satellite signal based on the first portion of the satellite signal and a third portion of the satellite signal that has the first bandwidth and spans the second time period.

Implementations of such an apparatus may include one or more of the following features. The apparatus includes means for transmitting an outbound signal that induces an interference signal inside the second bandwidth of the satellite signal and outside the first bandwidth of the satellite signal, and the means for determining the first code phase include means for determining the first code phase, instead of determining a third code phase, based on transmission of the outbound signal corresponding to the first time period, the third code phase corresponding to the first time period and being based on the second portion of the satellite signal. The apparatus includes: means for determining a third code phase of the satellite signal, corresponding to the first time period, based on the second portion of the satellite signal; and means for selecting one of the first code phase or the third code phase, to use to determine position information, based on expected interference with the second portion of the satellite signal, or based on actual interference with the second portion of the satellite signal, or a combination thereof. The apparatus includes means for transmitting an outbound signal that induces an interference signal inside the second bandwidth of the satellite signal and outside the first bandwidth of the satellite signal, and the means for selecting one of the first code phase and the third code phase include means for selecting the first code phase, to use to determine the position information, based on transmission of the outbound signal corresponding to the first time period and for selecting the third code phase to use to determine the position information otherwise. The second bandwidth includes the first bandwidth.

An example non-transitory, processor-readable storage medium includes processor-readable instructions to cause a processor to: receive a satellite signal; determine a first code phase of the satellite signal, corresponding to a first time period, based on a first portion of the satellite signal that has a first bandwidth; determine a second code phase of the satellite signal, corresponding to a second time period, based on a second portion of the satellite signal that has a second bandwidth, where the second bandwidth is larger than the first bandwidth, and where the second time period is separate from the first time period; and determine a carrier phase of the satellite signal based on the first portion of the satellite signal and a third portion of the satellite signal that has the first bandwidth and spans the second time period.

Implementations of such a storage medium may include one or more of the following features. The storage medium includes processor-readable instructions to cause the processor to transmit an outbound signal that induces an interference signal inside the second bandwidth of the satellite signal and outside the first bandwidth of the satellite signal, and the processor-readable instructions to cause the processor to determine the first code phase include processor-readable instructions to cause the processor to determine the first code phase, instead of determining a third code phase, based on transmission of the outbound signal corresponding to the first time period, the third code phase corresponding to the first time period and being based on the second portion of the satellite signal. The storage medium includes processor-readable instructions to cause the processor to: determine a third code phase of the satellite signal, corresponding to the first time period, based on the second portion of the satellite signal; and select one of the first code phase or the third code phase, to use to determine position information, based on expected interference with the second portion of the satellite signal, or based on actual interference with the second portion of the satellite signal, or a combination thereof. The storage medium includes processor-readable instructions to cause the processor to transmit an outbound signal that induces an interference signal inside the second bandwidth of the satellite signal and outside the first bandwidth of the satellite signal, and the processor-readable instructions to cause the processor to select one of the first code phase and the third code phase include processor-readable instructions to cause the processor to select the first code phase, to use to determine the position information, based on transmission of the outbound signal corresponding to the first time period and to select the third code phase to use to determine the position information otherwise. The second bandwidth includes the first bandwidth.

### BRIEF DESCRIPTION OF THE DRAWINGS

FIG. 1 is a simplified diagram of an example wireless communications system.

FIG. 2 is a block diagram of components of an example user equipment shown in FIG. 1.

FIG. 3 is a block diagram of components of an example transmission/reception point.

FIG. 4 is a block diagram of components of an example server, various embodiments of which are shown in FIG. 1.

FIG. 5 is a timing diagram of a code phase signal transition and a carrier signal.

FIG. 6 is a diagram of power distribution of a satellite signal as a function of frequency, and indications of possible interference signals.

FIG. 7 is a simplified block diagram of an example user equipment.

FIG. 8 is a block diagram of components of an example of the user equipment shown in FIG. 8.

FIG. 9 is a block diagram of components of another example of the user equipment shown in FIG. 8.

FIG. 10 is a block flow diagram of a method of measuring a satellite signal.

### DETAILED DESCRIPTION

Techniques are discussed herein for measuring code phase and carrier phase of satellite signals with and without the presence of interference. For example, a device may transmit one or more outbound signals (e.g., communication signals) that may produce one or more interference signals (e.g., signal harmonic(s), intermodulation signal(s)) at one or more interference frequencies that may interfere with inbound satellite signals. The device may make carrier-phase measurements of the satellite signal using a bandwidth of the satellite signal, that excludes the interference frequency(ies), consistently over time without regard to whether the interference may be present. The device may use code-phase and Doppler measurements based on a bandwidth that excludes the interference frequency(ies) corresponding to times that the potential interference is not present, or not expected to be present, and may use code-phase measurements based on another bandwidth that includes the interference frequency(ies) corresponding to times that the potential interference is present, or is expected to be present. The device may determine whether the interference is present, or expected to be present, based on times during which the device transmits (e.g., is transmitting or is scheduled to transmit) the outbound signal(s). These are examples, and other examples may be implemented.

Items and/or techniques described herein may provide one or more of the following capabilities, as well as other capabilities not mentioned. Positioning accuracy may be improved, e.g., by avoiding cycle slips in carrier-phase measurements due to changing from circuitry measuring one bandwidth of a satellite signal to circuitry measuring another bandwidth of the satellite signal. Code phase measurement accuracy may be improved, e.g., by determining code phase using a larger bandwidth of a satellite signal (and thus obtaining a sharper correlation peak) in the absence of known interference and a smaller bandwidth of the satellite signal (and thus avoiding signal degradation due to noise) when the known interference is present in the larger bandwidth but not the smaller bandwidth. Other capabilities may be provided and not every implementation according to the disclosure must provide any, let alone all, of the capabilities discussed. Further, it may be possible for an effect noted above to be achieved by means other than that noted, and a noted item/technique may not necessarily yield the noted effect.

Obtaining the locations of mobile devices may be useful for many applications including, for example, emergency calls, personal navigation, consumer asset tracking, locating a friend or family member, etc. Positioning methods include methods based on measuring radio signals transmitted from a variety of devices or entities including satellite vehicles (SVs) and terrestrial radio sources in a wireless network such as base stations and access points.

The description may refer to sequences of actions to be performed, for example, by elements of a computing device. Various actions described herein can be performed by specific circuits (e.g., an application specific integrated circuit (ASIC)), by program instructions being executed by one or more processors, or by a combination of both. Sequences of actions described herein may be embodied within a non-transitory computer-readable medium having stored thereon a corresponding set of computer instructions that upon execution would cause an associated processor to perform the functionality described herein. Thus, the various aspects described herein may be embodied in a number of different forms, all of which are within the scope of the disclosure, including claimed subject matter.

As used herein, the terms “user equipment” (UE) and “base station” are not specific to or otherwise limited to any particular Radio Access Technology (RAT), unless otherwise noted. In general, such UEs may be any wireless communication device (e.g., a mobile phone, router, tablet computer, laptop computer, consumer asset tracking device, Internet of Things (IoT) device, etc.) used by a user to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, WiFi networks (e.g., based on IEEE 802.11 (Institute of Electrical and Electronics Engineers 802.11 standard), etc.) and so on.

A base station may operate according to one of several RATs in communication with UEs depending on the network in which it is deployed, and may be alternatively referred to as an Access Point (AP), a Network Node, a NodeB, an evolved NodeB (eNB), a general Node B (gNodeB, gNB), etc. In addition, in some systems a base station may provide purely edge node signaling functions while in other systems it may provide additional control and/or network management functions.

UEs may be embodied by any of a number of types of devices including but not limited to printed circuit (PC) cards, compact flash devices, external or internal modems, wireless or wireline phones, smartphones, tablets, consumer asset tracking devices, asset tags, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

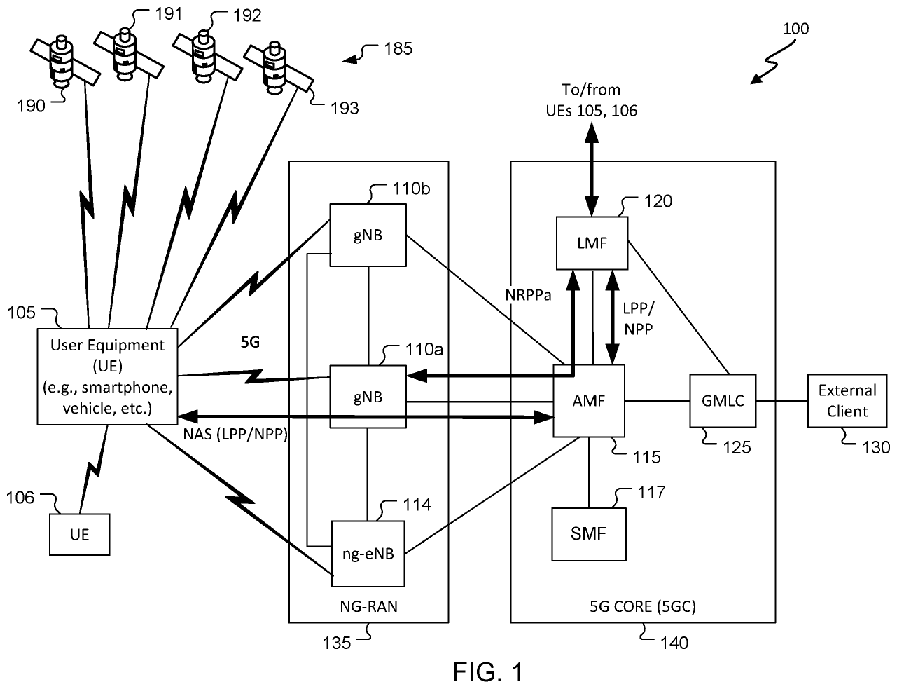

Referring to FIG. 1, an example of a communication system 100 includes a UE 105, a UE 106, a Radio Access Network (RAN) 135, here a Fifth Generation (5G) Next Generation (NG) RAN (NG-RAN), and a 5G Core Network (5GC) 140. The UE 105 and/or the UE 106 may be, e.g., an IoT device, a location tracker device, a cellular telephone, a vehicle (e.g., a car, a truck, a bus, a boat, etc.), or other device. A 5G network may also be referred to as a New Radio (NR) network; NG-RAN 135 may be referred to as a 5G RAN or as an NR RAN; and 5GC 140 may be referred to as an NG Core network (NGC). Standardization of an NG-RAN and 5GC is ongoing in the 3rd Generation Partnership Project (3GPP). Accordingly, the NG-RAN 135 and the 5GC 140 may conform to current or future standards for 5G support from 3GPP. The RAN 135 may be another type of RAN, e.g., a 3G RAN, a 4G Long Term Evolution (LTE) RAN, etc. The UE 106 may be configured and coupled similarly to the UE 105 to send and/or receive signals to/from similar other entities in the system 100, but such signaling is not indicated in FIG. 1 for the sake of simplicity of the figure. Similarly, the discussion focuses on the UE 105 for the sake of simplicity. The communication system 100 may utilize information from a constellation 185 of satellite vehicles (SVs) 190, 191, 192, 193 for a Satellite Positioning System (SPS) (e.g., a Global Navigation Satellite System (GNSS)) like the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS). Additional components of the communication system 100 are described below. The communication system 100 may include additional or alternative components.

As shown in FIG. 1, the NG-RAN 135 includes NR nodeBs (gNBs) 110a, 110b, and a next generation eNodeB (ng-eNB) 114, and the 5GC 140 includes an Access and Mobility Management Function (AMF) 115, a Session Management Function (SMF) 117, a Location Management Function (LMF) 120, and a Gateway Mobile Location Center (GMLC) 125. The gNBs 110a, 110b and the ng-eNB 114 are communicatively coupled to each other, are each configured to bi-directionally wirelessly communicate with the UE 105, and are each communicatively coupled to, and configured to bi-directionally communicate with, the AMF 115. The gNBs 110a, 110b, and the ng-eNB 114 may be referred to as base stations (BSs). The AMF 115, the SMF 117, the LMF 120, and the GMLC 125 are communicatively coupled to each other, and the GMLC is communicatively coupled to an external client 130. The SMF 117 may serve as an initial contact point of a Service Control Function (SCF) (not shown) to create, control, and delete media sessions. The BSs 110a, 110b, 114 may be a macro cell (e.g., a high-power cellular base station), or a small cell (e.g., a low-power cellular base station), or an access point (e.g., a short-range base station configured to communicate with short-range technology such as WiFi, WiFi-Direct (WiFi-D), Bluetooth®, Bluetooth®-low energy (BLE), Zigbee, etc. One or more of the BSs 110a, 110b, 114 may be configured to communicate with the UE 105 via multiple carriers. Each of the BSs 110a, 110b, 114 may provide communication coverage for a respective geographic region, e.g. a cell. Each cell may be partitioned into multiple sectors as a function of the base station antennas.

FIG. 1 provides a generalized illustration of various components, any or all of which may be utilized as appropriate, and each of which may be duplicated or omitted as necessary. Specifically, although only one UE 105 is illustrated, many UEs (e.g., hundreds, thousands, millions, etc.) may be utilized in the communication system 100. Similarly, the communication system 100 may include a larger (or smaller) number of SVs (i.e., more or fewer than the four SVs 190-193 shown), gNBs 110a, 110b, ng-eNBs 114, AMFs 115, external clients 130, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

The UE 105 may comprise and/or may be referred to as a device, a mobile device, a wireless device, a mobile terminal, a terminal, a mobile station (MS), a Secure User Plane Location (SUPL) Enabled Terminal (SET), or by some other name. Moreover, the UE 105 may correspond to a cellphone, smartphone, laptop, tablet, PDA, consumer asset tracking device, navigation device, Internet of Things (IoT) device, health monitors, security systems, smart city sensors, smart meters, wearable trackers, or some other portable or moveable device.

The UE 105 may include a single entity or may include multiple entities such as in a personal area network where a user may employ audio, video and/or data I/O (input/output) devices and/or body sensors and a separate wireline or wireless modem. An estimate of a location of the UE 105 may be referred to as a location, location estimate, location fix, fix, position, position estimate, or position fix, and may be geographic, thus providing location coordinates for the UE 105 (e.g., latitude and longitude) which may or may not include an altitude component (e.g., height above sea level, height above or depth below ground level, floor level, or basement level). Alternatively, a location of the UE 105 may be expressed as a civic location (e.g., as a postal address or the designation of some point or small area in a building such as a particular room or floor). A location of the UE 105 may be expressed as an area or volume (defined either geographically or in civic form) within which the UE 105 is expected to be located with some probability or confidence level (e.g., 67%, 95%, etc.). A location of the UE 105 may be expressed as a relative location comprising, for example, a distance and direction from a known location. The relative location may be expressed as relative coordinates (e.g., X, Y (and Z) coordinates) defined relative to some origin at a known location which may be defined, e.g., geographically, in civic terms, or by reference to a point, area, or volume, e.g., indicated on a map, floor plan, or building plan. In the description contained herein, the use of the term location may comprise any of these variants unless indicated otherwise. When computing the location of a UE, it is common to solve for local x, y, and possibly z coordinates and then, if desired, convert the local coordinates into absolute coordinates (e.g., for latitude, longitude, and altitude above or below mean sea level).

The UE 105 may be configured to communicate with other entities using one or more of a variety of technologies to determine and/or provide location information for the UE 105. The UE 105 may be configured to connect indirectly to one or more communication networks via one or more device-to-device (D2D) peer-to-peer (P2P) links. The D2D P2P links may be supported with any appropriate D2D radio access technology (RAT), such as LTE Direct (LTE-D), WiFi Direct (WiFi-D), Bluetooth®, and so on. One or more of a group of UEs utilizing D2D communications may be within a geographic coverage area of a Transmission/Reception Point (TRP) such as one or more of the gNBs 110a, 110b, and/or the ng-eNB 114.

As noted, while FIG. 1 depicts nodes configured to communicate according to 5G communication protocols, nodes configured to communicate according to other communication protocols, such as, for example, an LTE protocol or IEEE 802.11x protocol, may be used. For example, in an Evolved Packet System (EPS) providing LTE wireless access to the UE 105, a RAN may comprise an Evolved Universal Mobile Telecommunications System (UMTS) Terrestrial Radio Access Network (E-UTRAN) which may comprise base stations comprising evolved Node Bs (eNBs). A core network for EPS may comprise an Evolved Packet Core (EPC). An EPS may comprise an E-UTRAN plus EPC, where the E-UTRAN corresponds to the NG-RAN 135 and the EPC corresponds to the 5GC 140 in FIG. 1.

With a UE-based position method, the UE 105 may obtain location measurements and may compute a location of the UE 105 (e.g., with the help of assistance data received from a location server such as the LMF 120 or broadcast by the gNBs 110a, 110b, the ng-eNB 114, or other base stations or APs). The UE 105 may provide the location of the UE 105 to a server, e.g., directly and/or via a base station, such that the server can provide location information to a location client.

Information provided by the gNBs 110a, 110b, and/or the ng-eNB 114 to the LMF 120 using NRPPa may include timing and configuration information for directional SS transmissions and location coordinates. The LMF 120 may provide some or all of this information to the UE 105 as assistance data in an LPP (LTE Positioning Protocol) and/or NPP (New Radio Positioning Protocol) message via the NG-RAN 135 and the 5GC 140.

An LPP or NPP message sent from the LMF 120 to the UE 105 may instruct the UE 105 to do any of a variety of things depending on desired functionality. For example, the LPP or NPP message could contain an instruction for the UE 105 to obtain measurements for GNSS (or A-GNSS), WLAN, E-CID, and/or OTDOA (Observed Time Difference Of Arrival) (or some other position method).

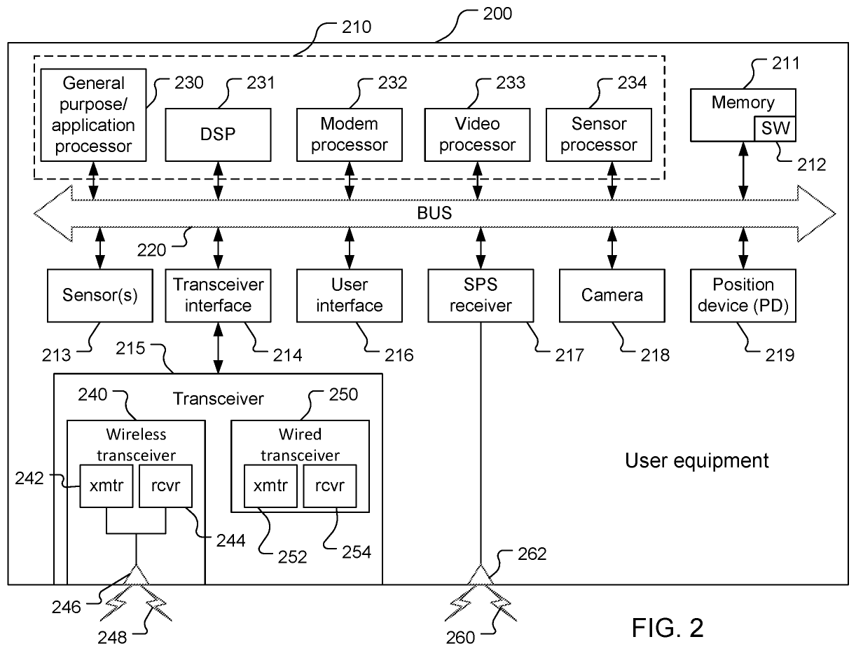

Referring also to FIG. 2, a UE 200 is an example of one of the UEs 105, 106 and comprises a computing platform including a processor 210, memory 211 including software (SW) 212, one or more sensors 213, a transceiver interface 214 for a transceiver 215 (that includes a wireless transceiver 240 and a wired transceiver 250), a user interface 216, a Satellite Positioning System (SPS) receiver 217, a camera 218, and a position device (PD) 219. The processor 210, the memory 211, the sensor(s) 213, the transceiver interface 214, the user interface 216, the SPS receiver 217, the camera 218, and the position device 219 may be communicatively coupled to each other by a bus 220 (which may be configured, e.g., for optical and/or electrical communication). One or more of the shown apparatus (e.g., the camera 218, the position device 219, and/or one or more of the sensor(s) 213, etc.) may be omitted from the UE 200. The processor 210 may include one or more intelligent hardware devices, e.g., a central processing unit (CPU), a microcontroller, an application specific integrated circuit (ASIC), etc. The processor 210 may comprise multiple processors including a general-purpose/application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for RF (radio frequency) sensing (with one or more (cellular) wireless signals transmitted and reflection(s) used to identify, map, and/or track an object), and/or ultrasound, etc. The modem processor 232 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 200 for connectivity. The memory 211 is a non-transitory storage medium that may include random access memory (RAM), flash memory, disc memory, and/or read-only memory (ROM), etc. The memory 211 stores the software 212 which may be processor-readable, processor-executable software code containing instructions that are configured to, when executed, cause the processor 210 to perform various functions described herein. Alternatively, the software 212 may not be directly executable by the processor 210 but may be configured to cause the processor 210, e.g., when compiled and executed, to perform the functions. The description may refer only to the processor 210 performing a function, but this includes other implementations such as where the processor 210 executes software and/or firmware. The description may refer to the processor 210 performing a function as shorthand for one or more of the processors 230-234 performing the function. The description may refer to the UE 200 performing a function as shorthand for one or more appropriate components of the UE 200 performing the function. The processor 210 may include a memory with stored instructions in addition to and/or instead of the memory 211. Functionality of the processor 210 is discussed more fully below.

The configuration of the UE 200 shown in FIG. 2 is an example and not limiting of the disclosure, including the claims, and other configurations may be used. For example, an example configuration of the UE includes one or more of the processors 230-234 of the processor 210, the memory 211, and the wireless transceiver 240. Other example configurations include one or more of the processors 230-234 of the processor 210, the memory 211, a wireless transceiver, and one or more of the sensor(s) 213, the user interface 216, the SPS receiver 217, the camera 218, the PD 219, and/or a wired transceiver.

The UE 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the processor 230 and/or the DSP 231. Other configurations, however, may be used to perform baseband processing.

The UE 200 may include the sensor(s) 213 that may include, for example, one or more of various types of sensors such as one or more inertial sensors, one or more magnetometers, one or more environment sensors, one or more optical sensors, one or more weight sensors, and/or one or more radio frequency (RF) sensors, etc. An inertial measurement unit (IMU) may comprise, for example, one or more accelerometers (e.g., collectively responding to acceleration of the UE 200 in three dimensions) and/or one or more gyroscopes (e.g., three-dimensional gyroscope(s)). The sensor(s) 213 may include one or more magnetometers (e.g., three-dimensional magnetometer(s)) to determine orientation (e.g., relative to magnetic north and/or true north) that may be used for any of a variety of purposes, e.g., to support one or more compass applications. The environment sensor(s) may comprise, for example, one or more temperature sensors, one or more barometric pressure sensors, one or more ambient light sensors, one or more camera imagers, and/or one or more microphones, etc. The sensor(s) 213 may generate analog and/or digital signals indications of which may be stored in the memory 211 and processed by the DSP 231 and/or the processor 230 in support of one or more applications such as, for example, applications directed to positioning and/or navigation operations.

The sensor(s) 213 may be used in relative location measurements, relative location determination, motion determination, etc. Information detected by the sensor(s) 213 may be used for motion detection, relative displacement, dead reckoning, sensor-based location determination, and/or sensor-assisted location determination. The sensor(s) 213 may be useful to determine whether the UE 200 is fixed (stationary) or mobile and/or whether to report certain useful information to the LMF 120 regarding the mobility of the UE 200. For example, based on the information obtained/measured by the sensor(s) 213, the UE 200 may notify/report to the LMF 120 that the UE 200 has detected movements or that the UE 200 has moved, and report the relative displacement/distance (e.g., via dead reckoning, or sensor-based location determination, or sensor-assisted location determination enabled by the sensor(s) 213). In another example, for relative positioning information, the sensors/IMU can be used to determine the angle and/or orientation of the other device with respect to the UE 200, etc.

The IMU may be configured to provide measurements about a direction of motion and/or a speed of motion of the UE 200, which may be used in relative location determination. For example, one or more accelerometers and/or one or more gyroscopes of the IMU may detect, respectively, a linear acceleration and a speed of rotation of the UE 200. The linear acceleration and speed of rotation measurements of the UE 200 may be integrated over time to determine an instantaneous direction of motion as well as a displacement of the UE 200. The instantaneous direction of motion and the displacement may be integrated to track a location of the UE 200. For example, a reference location of the UE 200 may be determined, e.g., using the SPS receiver 217 (and/or by some other means) for a moment in time and measurements from the accelerometer(s) and gyroscope(s) taken after this moment in time may be used in dead reckoning to determine present location of the UE 200 based on movement (direction and distance) of the UE 200 relative to the reference location.

The magnetometer(s) may determine magnetic field strengths in different directions which may be used to determine orientation of the UE 200. For example, the orientation may be used to provide a digital compass for the UE 200. The magnetometer(s) may include a two-dimensional magnetometer configured to detect and provide indications of magnetic field strength in two orthogonal dimensions. The magnetometer(s) may include a three-dimensional magnetometer configured to detect and provide indications of magnetic field strength in three orthogonal dimensions. The magnetometer(s) may provide means for sensing a magnetic field and providing indications of the magnetic field, e.g., to the processor 210.

The transceiver 215 may include a wireless transceiver 240 and a wired transceiver 250 configured to communicate with other devices through wireless connections and wired connections, respectively. For example, the wireless transceiver 240 may include a wireless transmitter 242 and a wireless receiver 244 coupled to one or more antennas 246 for transmitting (e.g., on one or more uplink channels and/or one or more sidelink channels) and/or receiving (e.g., on one or more downlink channels and/or one or more sidelink channels) wireless signals 248 and transducing signals from the wireless signals 248 to wired (e.g., electrical and/or optical) signals and from wired (e.g., electrical and/or optical) signals to the wireless signals 248. Thus, the wireless transmitter 242 may include multiple transmitters that may be discrete components or combined/integrated components, and/or the wireless receiver 244 may include multiple receivers that may be discrete components or combined/integrated components. The wireless transceiver 240 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (Vehicle-to-Everything) (PC5), IEEE 802.11 (including IEEE 802.11p), WiFi, WiFi Direct (WiFi-D), Bluetooth®, Zigbee etc. New Radio may use mm-wave frequencies and/or sub-6 GHz frequencies. The wired transceiver 250 may include a wired transmitter 252 and a wired receiver 254 configured for wired communication, e.g., a network interface that may be utilized to communicate with the network 135 to send communications to, and receive communications from, the network 135. The wired transmitter 252 may include multiple transmitters that may be discrete components or combined/integrated components, and/or the wired receiver 254 may include multiple receivers that may be discrete components or combined/integrated components. The wired transceiver 250 may be configured, e.g., for optical communication and/or electrical communication. The transceiver 215 may be communicatively coupled to the transceiver interface 214, e.g., by optical and/or electrical connection. The transceiver interface 214 may be at least partially integrated with the transceiver 215.

The user interface 216 may comprise one or more of several devices such as, for example, a speaker, microphone, display device, vibration device, keyboard, touch screen, etc. The user interface 216 may include more than one of any of these devices. The user interface 216 may be configured to enable a user to interact with one or more applications hosted by the UE 200. For example, the user interface 216 may store indications of analog and/or digital signals in the memory 211 to be processed by DSP 231 and/or the general-purpose processor 230 in response to action from a user. Similarly, applications hosted on the UE 200 may store indications of analog and/or digital signals in the memory 211 to present an output signal to a user. The user interface 216 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 216 may comprise one or more touch sensors responsive to touching and/or pressure, e.g., on a keyboard and/or touch screen of the user interface 216.

The SPS receiver 217 (e.g., a Global Positioning System (GPS) receiver) may be capable of receiving and acquiring SPS signals 260 via an SPS antenna 262. The antenna 262 is configured to transduce the wireless SPS signals 260 to wired signals, e.g., electrical or optical signals, and may be integrated with the antenna 246. The SPS receiver 217 may be configured to process, in whole or in part, the acquired SPS signals 260 for estimating a location of the UE 200. For example, the SPS receiver 217 may be configured to determine location of the UE 200 by trilateration using the SPS signals 260. The general-purpose processor 230, the memory 211, the DSP 231 and/or one or more specialized processors (not shown) may be utilized to process acquired SPS signals, in whole or in part, and/or to calculate an estimated location of the UE 200, in conjunction with the SPS receiver 217. The memory 211 may store indications (e.g., measurements) of the SPS signals 260 and/or other signals (e.g., signals acquired from the wireless transceiver 240) for use in performing positioning operations. The general-purpose processor 230, the DSP 231, and/or one or more specialized processors, and/or the memory 211 may provide or support a location engine for use in processing measurements to estimate a location of the UE 200.

The UE 200 may include the camera 218 for capturing still or moving imagery. The camera 218 may comprise, for example, an imaging sensor (e.g., a charge coupled device or a CMOS imager), a lens, analog-to-digital circuitry, frame buffers, etc. Additional processing, conditioning, encoding, and/or compression of signals representing captured images may be performed by the general-purpose processor 230 and/or the DSP 231. Also or alternatively, the video processor 233 may perform conditioning, encoding, compression, and/or manipulation of signals representing captured images. The video processor 233 may decode/decompress stored image data for presentation on a display device (not shown), e.g., of the user interface 216.

The position device (PD) 219 may be configured to determine a position of the UE 200, motion of the UE 200, and/or relative position of the UE 200, and/or time. For example, the PD 219 may communicate with, and/or include some or all of, the SPS receiver 217. The PD 219 may work in conjunction with the processor 210 and the memory 211 as appropriate to perform at least a portion of one or more positioning methods, although the description herein may refer only to the PD 219 being configured to perform, or performing, in accordance with the positioning method(s). The PD 219 may also or alternatively be configured to determine location of the UE 200 using terrestrial-based signals (e.g., at least some of the signals 248) for trilateration, for assistance with obtaining and using the SPS signals 260, or both. The PD 219 may be configured to use one or more other techniques (e.g., relying on the UE's self-reported location (e.g., part of the UE's position beacon)) for determining the location of the UE 200, and may use a combination of techniques (e.g., SPS and terrestrial positioning signals) to determine the location of the UE 200. The PD 219 may include one or more of the sensors 213 (e.g., gyroscope(s), accelerometer(s), magnetometer(s), etc.) that may sense orientation and/or motion of the UE 200 and provide indications thereof that the processor 210 (e.g., the processor 230 and/or the DSP 231) may be configured to use to determine motion (e.g., a velocity vector and/or an acceleration vector) of the UE 200. The PD 219 may be configured to provide indications of uncertainty and/or error in the determined position and/or motion. Functionality of the PD 219 may be provided in a variety of manners and/or configurations, e.g., by the general purpose/application processor 230, the transceiver 215, the SPS receiver 217, and/or another component of the UE 200, and may be provided by hardware, software, firmware, or various combinations thereof.

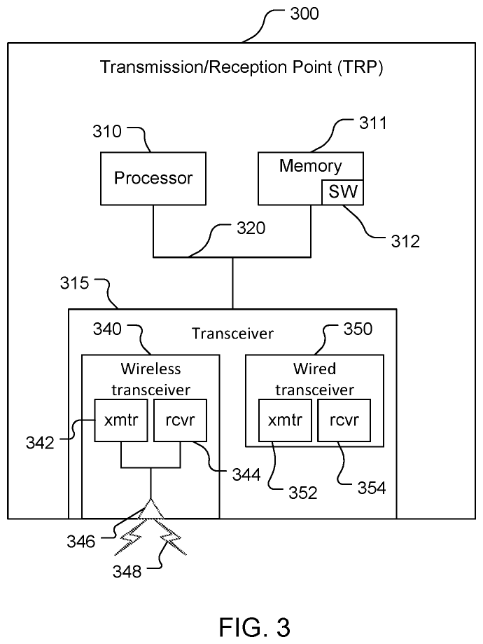

Referring also to FIG. 3, an example of a TRP 300 of the BSs 110a, 110b, 114 comprises a computing platform including a processor 310, memory 311 including software (SW) 312, and a transceiver 315. The processor 310, the memory 311, and the transceiver 315 may be communicatively coupled to each other by a bus 320 (which may be configured, e.g., for optical and/or electrical communication). One or more of the shown apparatus (e.g., a wireless interface) may be omitted from the TRP 300. The processor 310 may include one or more intelligent hardware devices, e.g., a central processing unit (CPU), a microcontroller, an application specific integrated circuit (ASIC), etc. The processor 310 may comprise multiple processors (e.g., including a general-purpose/application processor, a DSP, a modem processor, a video processor, and/or a sensor processor as shown in FIG. 2). The memory 311 is a non-transitory storage medium that may include random access memory (RAM)), flash memory, disc memory, and/or read-only memory (ROM), etc. The memory 311 stores the software 312 which may be processor-readable, processor-executable software code containing instructions that are configured to, when executed, cause the processor 310 to perform various functions described herein. Alternatively, the software 312 may not be directly executable by the processor 310 but may be configured to cause the processor 310, e.g., when compiled and executed, to perform the functions.

The description may refer only to the processor 310 performing a function, but this includes other implementations such as where the processor 310 executes software and/or firmware. The description may refer to the processor 310 performing a function as shorthand for one or more of the processors contained in the processor 310 performing the function. The description may refer to the TRP 300 performing a function as shorthand for one or more appropriate components (e.g., the processor 310 and the memory 311) of the TRP 300 (and thus of one of the BSs 110a, 110b, 114) performing the function. The processor 310 may include a memory with stored instructions in addition to and/or instead of the memory 311. Functionality of the processor 310 is discussed more fully below.

The transceiver 315 may include a wireless transceiver 340 and/or a wired transceiver 350 configured to communicate with other devices through wireless connections and wired connections, respectively. For example, the wireless transceiver 340 may include a wireless transmitter 342 and a wireless receiver 344 coupled to one or more antennas 346 for transmitting (e.g., on one or more uplink channels and/or one or more downlink channels) and/or receiving (e.g., on one or more downlink channels and/or one or more uplink channels) wireless signals 348 and transducing signals from the wireless signals 348 to wired (e.g., electrical and/or optical) signals and from wired (e.g., electrical and/or optical) signals to the wireless signals 348. Thus, the wireless transmitter 342 may include multiple transmitters that may be discrete components or combined/integrated components, and/or the wireless receiver 344 may include multiple receivers that may be discrete components or combined/integrated components. The wireless transceiver 340 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 350 may include a wired transmitter 352 and a wired receiver 354 configured for wired communication, e.g., a network interface that may be utilized to communicate with the network 135 to send communications to, and receive communications from, the LMF 120, for example, and/or one or more other network entities. The wired transmitter 352 may include multiple transmitters that may be discrete components or combined/integrated components, and/or the wired receiver 354 may include multiple receivers that may be discrete components or combined/integrated components. The wired transceiver 350 may be configured, e.g., for optical communication and/or electrical communication.

The configuration of the TRP 300 shown in FIG. 3 is an example and not limiting of the disclosure, including the claims, and other configurations may be used. For example, the description herein discusses that the TRP 300 is configured to perform or performs several functions, but one or more of these functions may be performed by the LMF 120 and/or the UE 200 (i.e., the LMF 120 and/or the UE 200 may be configured to perform one or more of these functions).

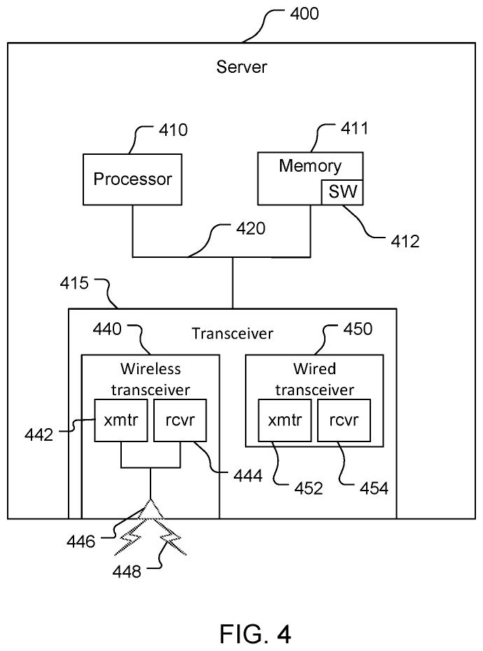

Referring also to FIG. 4, a server 400, of which the LMF 120 is an example, comprises a computing platform including a processor 410, memory 411 including software (SW) 412, and a transceiver 415. The processor 410, the memory 411, and the transceiver 415 may be communicatively coupled to each other by a bus 420 (which may be configured, e.g., for optical and/or electrical communication). One or more of the shown apparatus (e.g., a wireless interface) may be omitted from the server 400. The processor 410 may include one or more intelligent hardware devices, e.g., a central processing unit (CPU), a microcontroller, an application specific integrated circuit (ASIC), etc. The processor 410 may comprise multiple processors (e.g., including a general-purpose/application processor, a DSP, a modem processor, a video processor, and/or a sensor processor as shown in FIG. 2). The memory 411 is a non-transitory storage medium that may include random access memory (RAM)), flash memory, disc memory, and/or read-only memory (ROM), etc. The memory 411 stores the software 412 which may be processor-readable, processor-executable software code containing instructions that are configured to, when executed, cause the processor 410 to perform various functions described herein. Alternatively, the software 412 may not be directly executable by the processor 410 but may be configured to cause the processor 410, e.g., when compiled and executed, to perform the functions. The description may refer only to the processor 410 performing a function, but this includes other implementations such as where the processor 410 executes software and/or firmware. The description may refer to the processor 410 performing a function as shorthand for one or more of the processors contained in the processor 410 performing the function. The description may refer to the server 400 performing a function as shorthand for one or more appropriate components of the server 400 performing the function. The processor 410 may include a memory with stored instructions in addition to and/or instead of the memory 411. Functionality of the processor 410 is discussed more fully below.

The transceiver 415 may include a wireless transceiver 440 and/or a wired transceiver 450 configured to communicate with other devices through wireless connections and wired connections, respectively. For example, the wireless transceiver 440 may include a wireless transmitter 442 and a wireless receiver 444 coupled to one or more antennas 446 for transmitting (e.g., on one or more downlink channels) and/or receiving (e.g., on one or more uplink channels) wireless signals 448 and transducing signals from the wireless signals 448 to wired (e.g., electrical and/or optical) signals and from wired (e.g., electrical and/or optical) signals to the wireless signals 448. Thus, the wireless transmitter 442 may include multiple transmitters that may be discrete components or combined/integrated components, and/or the wireless receiver 444 may include multiple receivers that may be discrete components or combined/integrated components. The wireless transceiver 440 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 450 may include a wired transmitter 452 and a wired receiver 454 configured for wired communication, e.g., a network interface that may be utilized to communicate with the network 135 to send communications to, and receive communications from, the TRP 300, for example, and/or one or more other network entities. The wired transmitter 452 may include multiple transmitters that may be discrete components or combined/integrated components, and/or the wired receiver 454 may include multiple receivers that may be discrete components or combined/integrated components. The wired transceiver 450 may be configured, e.g., for optical communication and/or electrical communication.

The description herein may refer only to the processor 410 performing a function, but this includes other implementations such as where the processor 410 executes software (stored in the memory 411) and/or firmware. The description herein may refer to the server 400 performing a function as shorthand for one or more appropriate components (e.g., the processor 410 and the memory 411) of the server 400 performing the function.

The configuration of the server 400 shown in FIG. 4 is an example and not limiting of the disclosure, including the claims, and other configurations may be used. For example, the wireless transceiver 440 may be omitted. Also or alternatively, the description herein discusses that the server 400 is configured to perform or performs several functions, but one or more of these functions may be performed by the TRP 300 and/or the UE 200 (i.e., the TRP 300 and/or the UE 200 may be configured to perform one or more of these functions).

SPS Positioning Techniques

A UE may use a Satellite Positioning System (SPS) (a Global Navigation Satellite System (GNSS)) for high-accuracy positioning using precise point positioning (PPP) or real time kinematic (RTK) technology. These technologies use assistance data such as measurements from ground-based stations. LTE Release 15 allows the data to be encrypted so that only the UEs subscribed to the service can read the information. Such assistance data varies with time. Thus, a UE subscribed to the service may not easily “break encryption” for other UEs by passing on the assistance data to other UEs that have not paid for the subscription, with the assistance data being passed on each time the assistance data changes.

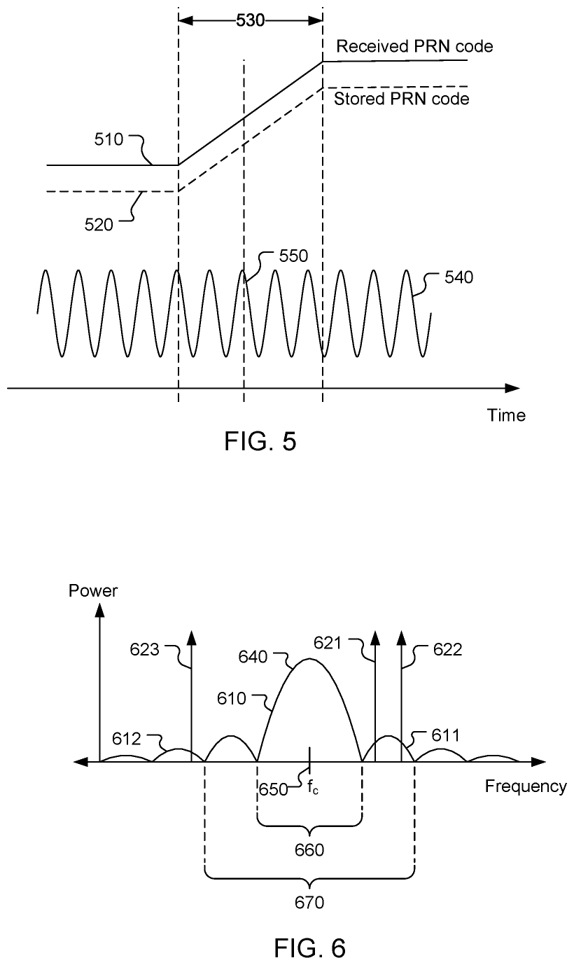

The SPS receiver 217 may be enabled to receive signals associated with one or more SPS/GNSS resources. Received SPS/GNSS signals may be stored in the memory 211 and/or used by processor(s) 210 to determine a position of UE the 200. The SPS receiver 217 may include a code phase receiver and a carrier phase receiver, which may measure carrier wave related information. The carrier wave, which typically has a much higher frequency than the pseudo random noise (PRN) (code phase) sequence that the carrier wave conveys, may facilitate more accurate position determination. The term “code-phase measurements” refers to measurements using a Coarse Acquisition (C/A) code receiver, which uses the information contained in the PRN sequence to calculate the position of the UE 200. Referring also to FIG. 5, the code phase receiver may align a received PRN code 510 with a stored PRN code 520. For simplicity of the diagram, modulation of a carrier signal 540 to produce the PRN code is not shown. Alignment of the received PRN code 510 with the stored code 520 may reveal a time of receipt of the received PRN code 510, within a time window 530, to determine a range between satellite and the UE 200, with multiple ranges between the UE 200 and multiple satellites used to determine the position of the UE 200, e.g., with 1-5 m accuracy. The phase of the carrier signal 540 conveying the PRN code 510 may be analyzed to determine a finer-resolution accuracy of the timing of arrival of a satellite signal at the UE 200, and thus the range between satellite and the UE 200, and consequently a more accurate position of the UE 200, e.g., less than 1 m (e.g., decimeters). For example, phase of the carrier signal 540 conveying the PRN code 510 may be analyzed for the window 530 to determine more accurately a timing of an edge of the received PRN code 510, in this example a cycle 550 being identified as the edge of a PRN code transition. The term “carrier-phase measurements” refers to measurements using a carrier phase receiver, which uses the carrier signal to calculate positions. The carrier signal may take the form, for example for GPS, of an L1 signal at 1575.42 MHz (which carries both a status message and a pseudo-random code for timing) or an L2 signal at 1227.60 MHz (which carries a more precise military pseudo-random code).

Carrier-phase measurements may be used to determine position in conjunction with code-phase measurements and differential techniques, e.g., when SPS signals that meet quality parameters are available. The use of carrier-phase measurements along with differential correction can yield relative sub-decimeter position accuracy. The UE 200 may use techniques based on or variants of real-time carrier phase differential GPS (CDGPS) to determine the position of the UE 200. The term “differential correction”, as used conventionally, refers to corrections to carrier-phase measurements determined by a reference station at a known location. The carrier-phase measurements at the reference station may be used to estimate residuals (e.g., portions not corrected by navigation messages) of satellite clock biases of visible satellites. The satellite clock biases are transmitted to “roving receivers” which use the received information to correct their respective measurements. A position p1 of the UE 200 at a time t1 may be considered as the “rover receiver” position, while a position p2 of the UE 200 at a time t2 may be considered the as the “reference receiver” position and differential techniques may be applied to reduce or remove errors induced by satellite clock biases. Because the same receiver is used at time t1 and t2, data may not be transmitted from the “reference” receiver (i.e., receiver at time t1) to the “rover” receiver (i.e., same receiver at time t2). Instead of the data transmission between rover and receiver that occurs in classical RTK, a local data buffering operation may be used to hold data at times t1 and t2.

The term “differential techniques” refers to techniques such as “single differencing”, “double differencing”, etc. where the qualifiers “single”, “double”, etc. refer traditionally to the number of satellites used in the differencing. In general, “single differencing” refers to error reduction techniques that subtract SPS carrier-phase measurements at the UE 200 from a single satellite S at time t2 from SPS carrier measurements at the UE 200 from the same satellite S at time t1. The term “double differencing”, as used in relation to embodiments described herein, refers to the carrier phase double difference observable between the times t1 and t2, which may be obtained as the difference between the above single difference carrier phase observable for a satellite S_i and the above single difference carrier phase observable for a satellite S_j.

The SPS receiver 217 may be included in a mobile device such as a vehicle, a mobile handset, a laptop, a computer, a tablet, an aerial vehicle or drone, or other SPS-enabled mobile device.

A position estimate (e.g., for a UE) may be referred to by other names, such as a location estimate, location, position, position fix, fix, or the like. A position estimate may be geodetic and comprise coordinates (e.g., latitude, longitude, and possibly altitude) or may be civic and comprise a street address, postal address, or some other verbal description of a location. A position estimate may further be defined relative to some other known location or defined in absolute terms (e.g., using latitude, longitude, and possibly altitude). A position estimate may include an expected error or uncertainty (e.g., by including an area or volume within which the location is expected to be included with some specified or default level of confidence).

SV Signal Measurement Based on Interference

Code-phase measurements and carrier-phase measurements may be used to determine location of a target UE with high precision. Using wider bandwidth correlation processing of an SV signal can provide better performance by yielding sharper code phase autocorrelation peaks, which provides reduced code-phase noise and potentially reduced multipath. The lower code-phase noise and a carrier-phase observable provide measurements for high-precision positioning and good integer ambiguity resolution characteristics (i.e., good ability to determine at which carrier phase cycle the SV signal arrives at the target UE). Using more bandwidth, however, may result in including interference, but limiting the bandwidth to avoid the inference may blur the correlation peak, resulting in lower code-phase accuracy.

In mobile devices such as smartphones, where small size and low cost is desired, close proximity of GNSS (circuitry and associated antennas) and WWAN (Wireless Wide Area Network), WLAN, BT, and/or other wireless technologies is common. Consequently, antenna-to-antenna isolation may be poor, resulting in interference into the GNSS spectrum, especially during transmit operation of one or more non-GNSS technologies where power levels are much higher, typically, than received signals. For example, as WWAN, WLAN, and BT are terrestrial-based technologies, the power levels of these technologies may be many tens of dB higher than GNSS signals (being satellite based). Filtering to reduce the interference to a level that has little impact on the GNSS signals may be impractical for low-cost, small-form-factor devices.

For example, referring also to FIG. 6, an SV signal 610 in the L1 GPS spectrum may have interference from one or more interference signals depending on the amount of bandwidth of the SV signal 610 that is used for measurement. Examples of interference signals include second or higher-order harmonics of signals in other frequency bands, signals with fundamental frequencies (which may be called first harmonics) in the frequency band of the signal to be measured (e.g., the SV signal 610), and/or one or more intermodulation signals (also called intermodulation distortion signals) with frequencies (e.g., the frequency sum and/or difference of multiple signals) in the frequency band of the signal to be measured. While the discussion herein may focus on harmonics as interference signals, the discussion is applicable to other types of interference signals such as intermodulation signals). As shown, a main lobe 640 of the SV signal 610 has a center frequency of 1575.42 MHz and spans +/−1 MHz, and an interference signal 621 caused by a second harmonic of a transmit signal (i.e., a signal transmitted by the device receiving the SV signal 610) in the B14 frequency band (in 5 MHz mode) and an interference signal 622 caused by a second harmonic of a transmit signal in the B14 frequency band (in 10 MHz mode) interfere with a first (upper) sidelobe 611 of the SV signal 610. Also as shown, an interference signal 623 caused by a second harmonic of a transmit signal in the B13 frequency band interferes with a second (lower) sidelobe 612 of the SV signal 610. Thus, if a main lobe 640 and the first sidelobe 611 of the SV signal 610 are used for measurement, then the SV signal 610 may be corrupted by the interference signals 621, 622, and if the second sidelobe 612 of the SV signal 610 is used, then the SV signal 610 may also be corrupted by the interference signal 623.

To avoid producing poor results from measurements of SV signals in the presence of interference (e.g., transmission interference), one or more precautions can be taken. For example, a UE may stop measurements, mark measurements as unusable, or blank measurements (set signal sample values to dummy values, e.g., null values) corresponding to times of transmission of interference-inducing signals. Marking measurements unusable results in loss of measurements (because measurements are made but not reported), and stopping measurements and blanking measurements results in cycle slips. For example, if enough samples are blanked, a measurement may not be obtained, and a carrier phase output will slip (called a cycle slip) such that a number of carrier phase cycles missed is unknown. Cycle slips reduce effectiveness of the precise carrier phase observable, and thus reduce positioning accuracy. Another possibility is to use energy from the main lobe (e.g., the main lobe 640) only of the SV signal, and forego wide bandwidth processing. For example, because the interference signals 621-623 are out of out-of-band relative to the main lobe 640, there is no in-band interference and thus stopping measurements and blanking can be avoided. The lower (smaller) bandwidth measurement may, however, result in higher code-phase noise, lower code-phase accuracy, and/or lower integer ambiguity performance. Another possibility is to switch between lower-bandwidth processing and higher-bandwidth processing, but this may result in cycle slips due to different processing entities for the lower-bandwidth and higher-bandwidth processing having different carrier phases.

A UE may be able to avoid cycle slips for carrier-phase measurements and also benefit from larger-bandwidth signal processing for code phase in the absence of interference (e.g., UE-transmission-induced interference, also called transmission interference or Tx interference). For example, a UE may use two tracking channels (e.g., hardware and/or software processing) for the same SV signal. One tracking channel processes at a lower bandwidth (e.g., main lobe only of the SV signal) while another channel processes with more bandwidth (e.g., as high of a bandwidth as the UE can without including interference (e.g., due to signal transmission by the UE)) to obtain a sharp autocorrelation function peak and a low code-phase noise. The UE may harvest the code phase from the higher-bandwidth channel in the absence of interference (e.g., Tx interference) and harvest the code phase from the lower-bandwidth channel if interference (e.g., Tx interference) is present. The UE may harvest carrier-phase measurements from the lower-bandwidth channel regardless of present or absence of interference, e.g., to avoid cycle slips and loss of carrier phase lock.

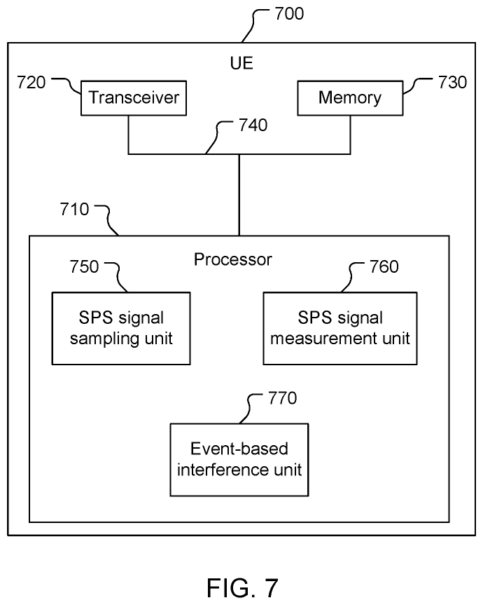

Referring to FIG. 7, a UE 700 includes a processor 710, a transceiver 720, and a memory 730 communicatively coupled to each other by a bus 740. The UE 700 may include the components shown in FIG. 7, and may include one or more other components such as any of those shown in FIG. 2 such that the UE 200 may be an example of the UE 700. For example, the processor 710 may include one or more of the components of the processor 210. The transceiver 720 may include the antenna 262 and one or more components of the SPS receiver 217, and may include one or more components of the transceiver 215, e.g., the wireless transmitter 242 and the antenna 246, or the wireless receiver 244 and the antenna 246, or the wireless transmitter 242, the wireless receiver 244, and the antenna 246, or the wired transmitter 252 and/or the wired receiver 254. The memory 730 may be configured similarly to the memory 211, e.g., including software with processor-readable instructions configured to cause the processor 710 to perform functions.

The description herein may refer only to the processor 710 performing a function, but this includes other implementations such as where the processor 710 executes software (stored in the memory 730) and/or firmware. The description herein may refer to the UE 700 performing a function as shorthand for one or more appropriate components (e.g., the processor 710 and the memory 730) of the UE 700 performing the function. The processor 710 (possibly in conjunction with the memory 730 and, as appropriate, the transceiver 720) may include a SPS signal sampling unit 750, a SPS signal measurement unit 760, and an event-based interference unit 770. The SPS signal sampling unit 750, the SPS signal measurement unit 760, and the event-based interference unit 770 are discussed further below, and the description may refer to the processor 710 generally, or the UE 700 generally, as performing any of the functions of the SPS signal sampling unit 750, the SPS signal measurement unit 760, and/or the event-based interference unit 770.

Event-based interference is interference that is induced by the occurrence of an event and is repeatable such that the interference induced by the event is known (e.g., of known frequency(ies) and magnitude(s)). The event-based interference unit 770 may have knowledge of the event-based interference, e.g., both the interference and the event that induces the interference. For example, the event-based interference may be Tx interference due to transmission of one or more signals by the UE 700, in which case the event-based interference unit 770 obtains knowledge of occurrence of the event from another portion of the processor 710, e.g., that controls transmission of communication signals. The event-based interference unit 770 may not have knowledge of the interference induced by an event, but have knowledge of what action to take to avoid negative effects of the interference, e.g., what measurement(s) to use and what measurement(s) not to use during the event. The event-based interference unit 770 may determine that Tx interference is presently occurring (e.g., from a notice of Tx transmission) and/or may determine the time of future Tx interference (e.g., from a Tx schedule). The event-based interference unit 770 may obtain an indication of an interference-inducing event from another portion of the UE 700 and/or from outside of the UE 700 (e.g., via the transceiver 720). The interference occurs at one or more known frequencies and/or in one or more known ranges of frequencies. Multiple events may occur that each induce interference and one or more interference-inducing events may end, causing the event-induced interference to end.

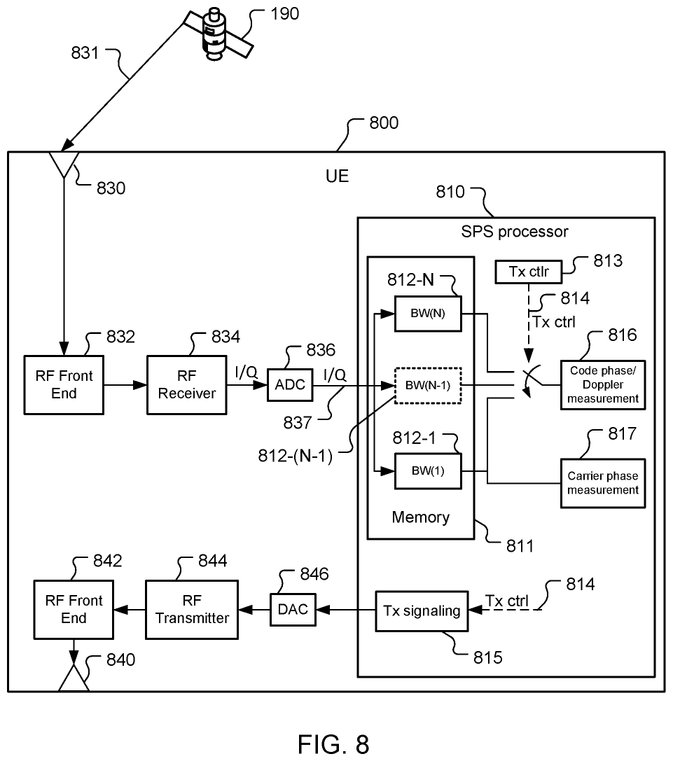

Referring also to FIG. 8, a UE 800 is an example of the UE 700. In this example, the UE 800 includes an SPS processor 810, an SPS antenna 830, an RF front end 832, an RF receiver 834, and an analog-to-digital converter (ADC) 836, a communication antenna 840, an RF front end 842, an RF transmitter 844, and a digital-to-analog converter (DAC) 846. The processor 810 includes a memory 811, a transmission controller 813, a transmission signaling unit 815, a code phase/Doppler measurement unit 816, and a carrier phase measurement unit 817. The units 815-817 may each be implemented, for example, by a hardware processor performing functions in accordance with software instructions. The Tx signaling unit 815 is configured to respond to reception of a transmission control signal 814 (Tx control signal) by producing a signal, e.g., a communication signal, to be transmitted from the UE 800 and providing this signal to the DAC 846 for conversion to digital and transmission from the UE 800 via the RF transmitter 844, the RF front end 842, and the antenna 840. The Tx signaling unit 815 may be omitted, e.g., if the transmission control signal 814 is the signal to be transmitted from the UE 800. The implementation shown in FIG. 8 is an example, and numerous other implementations may be used. For example, separate ADCs may be used for in-phase and quadrature-phase components of an incoming signal.

The UE 800 is configured to receive SPS signals and measure the SPS signals with different bandwidths. The antenna 830 is configured to receive SV signals 831 (e.g., from the SV 190), and the RF front end 832, the RF receiver 834, and the ADC 836 are configured to process the received SPS signal to produce a complex digital signal 837 with in-phase (I) and quadrature-phase (Q) components that are provided to the SPS processor 810. The SPS processor 810 is configured to filter the complex digital signal 837 into N different bandwidth portions, measure the N different bandwidth portions and store samples of the N different bandwidth portions in N sample memories 812-1-812-N of the memory 811. As shown, the N sample memories 812-1-812-N include at least three sample memories (812-1, 812-(N−1), 812-N), but more or fewer (e.g., two) sample memories may be used. The N sample memories 812-1-812-N store signal samples of N respective bandwidths (BW(1)-BW(N)). A bandwidth of a sample memory may be symmetric about a main lobe of an SPS signal (e.g., the main lobe 640) or asymmetric about the main lobe, e.g., extending further in frequency below a center frequency (e.g., a center frequency 650) of the main lobe than above the center frequency, or vice versa. Different bandwidths may overlap, e.g., being centered at the center frequency and extending for different amounts of frequencies with one or more bandwidths being lower (span fewer frequencies) than one or more higher bandwidths (spanning more frequencies). For example, the bandwidth BW(N) of the sample memory 812-N may be a higher bandwidth (larger bandwidth), spanning more frequencies, than the bandwidth BW(1) of the sample memory 812-1 such that the bandwidth BW(1) is a lower bandwidth (smaller bandwidth), spanning fewer frequencies, than the bandwidth BW(N).

The SPS processor 810 may be configured such that bandwidths corresponding to the sample memories 812-1-812-N include or exclude known interference and span respective desired frequency amounts (e.g., to help provide code phase resolution). For example, the SPS processor 810, e.g., the SPS signal sampling unit 750, may be configured to sample SPS signals over two bandwidths, a high bandwidth and a low bandwidth, and store the samples in two sample memories 812-1, 812-N (where N=2), with the low bandwidth being BW(1) and the high bandwidth being BW(N). The low bandwidth BW(1) may span frequencies that exclude event-based interference frequency(ies) while including sufficient energy of an SPS signal for carrier-phase measurement with acceptable accuracy. For example, the low bandwidth BW(1) may span at least most frequencies of a main lobe of an SPS signal such as a bandwidth 660 that spans the main lobe 640 (although a bandwidth that spans less than the main lobe 640 may be used). As another example, the low bandwidth BW(1) may span more frequencies than the main lobe but excluding the event-based interference (and possibly frequencies to make the low bandwidth BW(1) symmetrical about the main lobe). The high bandwidth BW(N) may span frequencies that include the frequency(ies) of at least some event-based interference, but may exclude the frequency(ies) of other event-based interference, e.g., where use of the extra bandwidth that includes the other event-based interference improves measurement accuracy (e.g., resolution) less than the event-based interference degrades the measurement accuracy, or where the bandwidth spans the frequencies of event-based interference due to one event but not event-based interference due to another event. For example, the low bandwidth BW(N) may be a bandwidth 670 that spans frequencies that include the interference signals 621, 622 caused by transmission in the B14 frequency band while excluding the interference signal 623 caused by transmission in the B13 frequency band. In this example, the bandwidth 660 may be about half of the bandwidth 670 (e.g., about 2 MHz compared to about 4 MHz).

The SPS processor 810 is configured to use different sampled portions of SPS signals selectively for code-phase measurements. The processor 810, e.g., the event-based interference unit 770, may determine when an event is occurring (and/or or will occur) that induces (and/or will induce) event-based interference and select to use different SPS signal samples of different bandwidths corresponding to times when the event-based interference is present or absent. When event-based interference is present, use of samples of a bandwidth including the event-based interference frequencies may result in corrupted and/or incorrect measurements. Thus, as code phase accuracy improves with greater bandwidth, to determine code-phase measurements, samples of a higher bandwidth may be used when the event-based interference is absent and samples of a lower bandwidth, that exclude the frequency(ies) of the event-based interference, may be used when the event-based interference is present. The discussion herein refers to event-based interference frequencies being excluded because while frequencies of the event-based interference may not be completely excluded due to practical implementations of filters, signal energy of the frequencies of the event-based interference may be sufficiently suppressed that the frequencies can be treated as though the frequencies are completely excluded.

The code phase/Doppler measurement unit 816 may determine code-phase and Doppler measurements based on SPS signal samples selected based on the presence or absence of event-based interference. For example, the event-based interference unit 770 monitors for the presence of the transmission control signal 814 and controls the SPS signal measurement unit 760 to select appropriate SPS signal samples to determine code phase and Doppler. For example, the SPS signal measurement unit 760 may determine the code phase by correlating the SV signal 831 with multiple hypothesis codes, e.g., interpolating the multiple hypotheses. The event-based interference unit 770 causes the SPS signal measurement unit 760 to determine the code phase of the SV signal 831 using low-bandwidth samples from the sample memory 812-1 corresponding to times during which event-based interference is present in high-bandwidth samples in the sample memory 812-N and not in the low-bandwidth samples, and using the high-bandwidth samples from the sample memory 812-N corresponding to times during which event-based interference is absent from the high-bandwidth samples. The code phase/Doppler measurement unit 816 may select one of the sample memories 812-N based on the frequency(ies) of expected interference and the corresponding bandwidth of the sample memory (e.g., based on which of multiple transmission signals is indicated by the transmission control signal 814). Numerous other examples are possible. For example, an implementation may be used that provides SV signal samples of the bandwidth 660, the bandwidth 670, and a full bandwidth of the SV signal 831. In this example, the bandwidth 660 may be used for code-phase and Doppler measurements in the presence of event-based interference in the full bandwidth but not the bandwidth 660 (whether in the bandwidth 670 or not), the bandwidth 670 may be used for code-phase and Doppler measurements in the presence of event-based interference outside the bandwidth 670 but not in the bandwidth 670, and the full bandwidth used for code-phase and Doppler measurements absent event-based interference in the full bandwidth of the SV signal 831. While the discussion herein for selecting a signal bandwidth for making code-phase measurements may apply to making Doppler measurements, the discussion may refer to making code-phase measurements, without reference to making Doppler measurements to simplify the discussion.

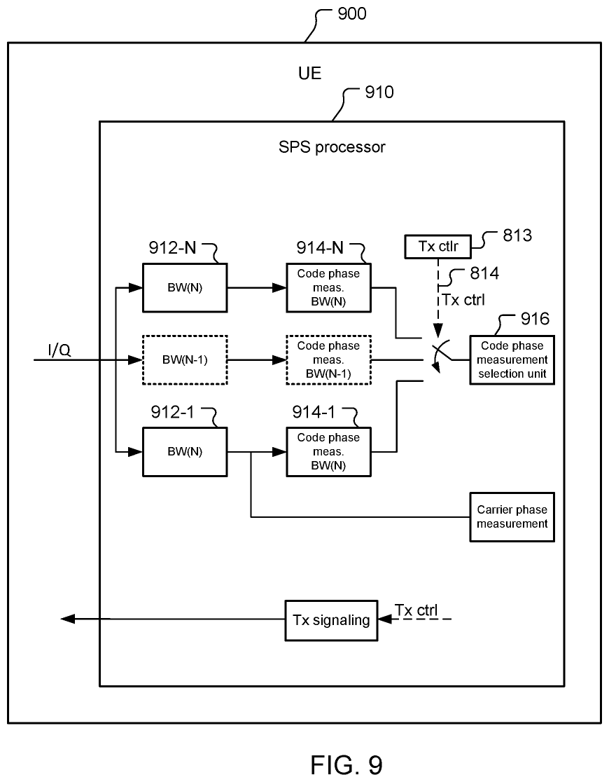

Other implementations are possible for selective bandwidth for code-phase measurements. For example, code-phase measurements may be made for SV signal samples of each of different bandwidths regardless of presence or absence of event-based interference, and the code-phase measurements selected, based on the presence or absence of event-based interference in the SPS signal samples corresponding to the measurements, for further processing (e.g., in determining pseudorange, location of the UE 800, etc.). Another example implementation may use a filter set that provides respective filtered portions of the complex digital signal 837 that can be selectively received by the code phase/Doppler measurement unit 816, e.g., with or without storing the filtered portions in memory. Referring also to FIG. 9, another example implementation may include a UE 900 that includes an SPS processor 910 that includes multiple bandwidth filters 912-1-912-N configured to filter an SV signal into different frequency bandwidths, and multiple code phase measurement units 914-1-914-N for determining code phase using the different signal bandwidths. A code phase measurement selection unit 916 may select, in response to the transmission control signal 814 (and thus the known interference with the SV signal) and based on the bandwidth used to determine the respective code phase measurement, the output of one of the code phase measurement units 914-1-914-N for further processing, e.g., to determine a pseudorange. The code phase measurement selection unit 916 may determine whether actual interference is present with the SV signal 831 in the code phase measurements (e.g., based on respective SNR measurements), and may select the code phase measurement based on the actual interference and/or expected interference (e.g., based on the transmission control signal 814 indicating transmission of a signal expected to interfere with the SV signal 831). The SPS processor 810 and/or the SPS processor 910 may include one or more hardware components, e.g., to obtain SV signal samples for different bandwidths, without software. Alternatively, the functionality of the SPS processor 810 and/or the SPS processor 910 discussed herein may be implemented by a processor executing software instructions. Still other implementations may be used.

The carrier phase measurement unit 817 draws from the low-bandwidth samples stored in the sample memory 812-1 regardless of the presence or absence of event-based interference because the bandwidth used to determine the low-bandwidth samples excludes the event-based interference frequencies. The carrier phase measurement unit 817 may determine the carrier phase of the SV signal 831 by performing one or more appropriate functions such as an arctangent on the low-bandwidth samples. By harvesting the low-bandwidth samples, cycle slips are avoided, e.g., by avoiding switching between circuitry providing code-phase measurements using low-bandwidth samples and circuitry providing code-phase measurements using high-bandwidth samples. For example, a system having a low-bandwidth channel and a high-bandwidth channel may select the high-bandwidth channel absent interference and the low-bandwidth channel when interference is present, and use the selected channel for code phase and carrier-phase measurements, which may induce cycle slips in the carrier-phase measurements. Such cycle slips are avoided by using the low-bandwidth samples from the sample memory 812-1 consistently, even while code-phase measurements switch between using low-bandwidth samples and high-bandwidth samples. Switching for code-phase measurements may be performed while maintaining acceptable quality because measurements of dwells (time to detect presence of an SV signal for combinations of parameters) are effectively independent measurements.

The carrier phase measurement unit 817 can consistently draw from low-bandwidth samples for carrier-phase measurements with good performance. Because carrier phase is a relative measurement, carrier phase may be referenced from a channel (apparatus determining a measurement) separate from a code-phase channel provided the carrier-phase channel is consistent over time with the code-phase channel. Here, the carrier-phase channel and code-phase channel are consistent because both channels measure the same fundamental signal, e.g., the SV signal 831. Carrier-phase measurement uses power, and thus increasing signal bandwidth to increase I/Q signal power may decrease effects of noise, which may improve the carrier-phase measurement, unless increasing the bandwidth comes with increased noise. Also, because carrier-phase fidelity is a function of processed signal power in coherent IQ sums, and the main lobe of an SV signal contains over 90% of total full-bandwidth power of the SV signal, a low-bandwidth channel using the main lobe has less than 0.46 dB less power than a full-bandwidth channel. Using the main-lobe power instead of the full-bandwidth power translates to an insignificant difference in carrier-phase noise standard deviation, especially relative to noise sources such as multipath.

Numerous implementations may be used for selectively measuring code phase with different signal bandwidths and measuring carrier phase with a consistent signal bandwidth. For example, as shown in FIG. 8, some hardware may be shared between channels for code-phase measurements and carrier-phase measurements. A primary channel can provide low-bandwidth SV signal samples and/or measurements and a secondary channel can provide high-bandwidth SV signal samples and/or measurements. The secondary channel may share one or more components with the primary channel. Another example implementation may use a first channel for producing low-bandwidth SV samples and/or measurements and a second channel, independent of the first channel, for producing high-bandwidth SV samples and/or measurements. In this implementation, the first and second channels, being independent, have separate component sets (without sharing any components).

Implementations discussed herein may be used with a variety of SV signals. For example, signals from various constellations (e.g., GPS, GAL, GLO, BDS, Navic, and/or QXSS) and/or of various frequencies (e.g., L1, L2, L5, L6, etc.) may be processed as discussed herein. As another example, various bandwidths and/or combinations of different bandwidths may be used. For example, bandwidths that are asymmetric about a center frequency of an SV signal may be used. Bandwidths spanning less than an entire main lobe of an SV signal may be used. Bandwidths that span partial lobes of an SV signal may be used. Still other implementations may be used.

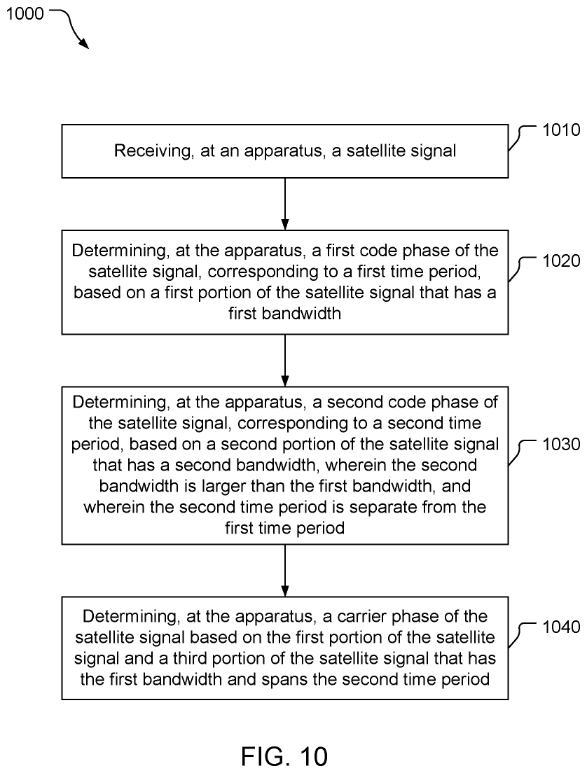

Referring to FIG. 10, with further reference to FIGS. 1-8, a method 1000 of measuring a satellite signal includes the stages shown. The method 1000 is, however, an example only and not limiting. The method 1000 may be altered, e.g., by having stages added, removed, rearranged, combined, performed concurrently, and/or having single stages split into multiple stages.

At stage 1010, the method 1000 includes receiving, at an apparatus, a satellite signal. For example, the UE 800 receives the SV signal 831. The antenna 830 (e.g., the antenna 262) may comprise means for receiving the satellite signal. As another example, the transceiver 720 (e.g., the SPS receiver 217 and the antenna 262) and the processor 710 (e.g., the SPS processor 810) may comprise means for receiving the satellite signal.

At stage 1020, the method 1000 includes determining, at the apparatus, a first code phase of the satellite signal, corresponding to a first time period, based on a first portion of the satellite signal that has a first bandwidth. For example, the SPS processor 810 or the SPS processor 910 determines code phase using a low-bandwidth portion of the SV signal 831 corresponding to a time where interference is present in a bandwidth of the SV signal 831 that is larger than the first bandwidth. The first code phase may be determined consistently by the SPS processor 910 (e.g., whether the interference is present or not), or determined by the SPS processor 810 in response to a determination that the interference is, or is expected to be, present. The processor 710, possibly in combination with the memory 730, may comprise means for determining the first code phase of the satellite signal.

At stage 1030, the method 1000 includes determining, at the apparatus, a second code phase of the satellite signal, corresponding to a second time period, based on a second portion of the satellite signal that has a second bandwidth, where the second bandwidth is larger than the first bandwidth, and where the second time period is separate from the first time period. For example, the SPS processor 810 or the SPS processor 910 determines code phase using a high-bandwidth portion of the SV signal 831 corresponding to a time where interference is absent from the second bandwidth of the SV signal 831, the second bandwidth being larger than the first bandwidth. The first code phase may be determined consistently by the SPS processor 910 (e.g., whether the interference is present or not), or determined by the SPS processor 810 in response to a determination that the interference is, or is expected to be, absent. The processor 710, possibly in combination with the memory 730, may comprise means for determining the second code phase of the satellite signal.

At stage 1040, the method 1000 includes determining, at the apparatus, a carrier phase of the satellite signal based on the first portion of the satellite signal and a third portion of the satellite signal that has the first bandwidth and spans the second time period. For example, the SPS processor 810 or the SPS processor 910 determines carrier phase using the low-bandwidth portion of the SV signal 831 consistently, e.g., at times with the interference being present and at times with the interference being absent. The processor 710, possibly in combination with the memory 730, may comprise means for determining the carrier phase of the satellite signal.

Implementations of the method 1000 may include one or more of the following features. In an example implementation, the method 1000 comprises transmitting, from the apparatus, an outbound signal that induces an interference signal inside the second bandwidth of the satellite signal and outside the first bandwidth of the satellite signal, and determining the first code phase comprises determining the first code phase, instead of determining a third code phase, based on transmission of the outbound signal corresponding to the first time period, the third code phase corresponding to the first time period and being based on the second portion of the satellite signal. For example, the code phase/Doppler measurement unit 816 responds to the transmission control signal 814 indicating (present or future) transmission by the antenna 840, the RF front end 842, the RF transmitter, and the DAC 846 of a signal that may interfere with the SV signal 831 by determining to use the low-bandwidth samples from the sample memory 812-1 (corresponding to the time of transmission), instead of the high-bandwidth samples from the sample memory 812-N, to determine code phase for determining range from the SV 190 to the UE 800. The processor 710, possibly in combination with the memory 730, may comprise means for determining the first code phase instead of the third code phase. The antenna 840, the RF front end 842, the RF transmitter, the DAC 846, the transmission controller 813, and the Tx signaling unit 815 may comprise means for transmitting the outbound signal. In another example implantation, the second bandwidth includes the first bandwidth. For example, the bandwidth 670 includes the bandwidth 660, although other examples of bandwidths may be used, e.g., that partially overlap or are completely separate.

Also or alternatively, implementations of the method 1000 may include one or more of the following features. In an example implementation, the method comprises determining a third code phase of the satellite signal, corresponding to the first time period, based on the second portion of the satellite signal; and selecting one of the first code phase or the third code phase, to use to determine position information, based on expected interference with the second portion of the satellite signal, or based on actual interference with the second portion of the satellite signal, or a combination thereof. For example, the SPS processor 910 determines multiple code phase measurements using the code phase measurement units 914-1-914-N and selects one of the code phase measurements based on expected interference corresponding to the transmission control signal 814 indicating signal transmission and/or based on actual interference with the SV signal 831, e.g., as determined from an SNR measurement for each of the code phase measurements. Thus, the selecting may be proactive (e.g., based on expectations) or reactive (e.g., based on SNR measurement(s)). The processor 710, possibly in combination with the memory 730, may comprise means for determining the third code phase and means for selecting one of the first code phase or the third code phase to use to determine position information (e.g., pseudorange between the SV 190 and the UE 900). In another example implementation, the method comprises transmitting, from the apparatus, an outbound signal that induces an interference signal inside the second bandwidth of the satellite signal and outside the first bandwidth of the satellite signal; and selecting the first code phase to use to determine the position information based on transmission of the outbound signal corresponding to the first time period and selecting the third code phase to use to determine the position information otherwise. For example, the code phase measurement selection unit 916 responds to the transmission control signal 814 indicating (present or future) transmission by the antenna 840, the RF front end 842, the RF transmitter, and the DAC 846 of an outbound signal with a harmonic in the frequency bandwidth 670 but outside the frequency bandwidth 660 by selecting the code phase determined using the frequency bandwidth 660 by the code phase measurement unit 914-1 based on expected or actual interference with the SV signal 831 corresponding to transmission of the outbound signal. The antenna 840, the RF front end 842, the RF transmitter, the DAC 846, the transmission controller 813, and the Tx signaling unit 815 may comprise means for transmitting the outbound signal. The processor 710, possibly in combination with the memory 730, may comprise means for selecting the first code phase or the third code phase to use to determine the position information.

Other Considerations

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

As used herein, unless otherwise stated, a statement that a function or operation is “based on” an item or condition means that the function or operation is based on the stated item or condition and may be based on one or more items and/or conditions in addition to the stated item or condition.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

1. An apparatus comprising:
a satellite positioning system receiver;
a memory; and
a processor communicatively coupled to the satellite positioning system receiver, and the memory, the processor being configured to:
receive a satellite signal via the satellite positioning system receiver;
determine a first code phase of the satellite signal, corresponding to a first time period, based on a first portion of the satellite signal that has a first bandwidth;
determine a second code phase of the satellite signal, corresponding to a second time period, based on a second portion of the satellite signal that has a second bandwidth, wherein the second bandwidth is larger than the first bandwidth, and wherein the second time period is separate from the first time period; and
determine a carrier phase of the satellite signal based on the first portion of the satellite signal and a third portion of the satellite signal that has the first bandwidth and spans the second time period.

2. The apparatus of claim 1, wherein:
the apparatus comprises a transmitter communicatively coupled to the processor;
the processor is configured to transmit, via the transmitter, an outbound signal that induces an interference signal inside the second bandwidth of the satellite signal and outside the first bandwidth of the satellite signal; and
the processor is configured to determine the first code phase, instead of determining a third code phase, based on transmission of the outbound signal corresponding to the first time period, the third code phase corresponding to the first time period and being based on the second portion of the satellite signal.

3. The apparatus of claim 1, wherein the processor is configured to determine a third code phase of the satellite signal, corresponding to the first time period, based on the second portion of the satellite signal, and wherein the processor is configured to select one of the first code phase or the third code phase, to use to determine position information, based on expected interference with the second portion of the satellite signal, or based on actual interference with the second portion of the satellite signal, or a combination thereof.

4. The apparatus of claim 3, wherein the apparatus comprises a transmitter communicatively coupled to the processor, and wherein the processor is configured to:
transmit, via the transmitter, an outbound signal that induces an interference signal inside the second bandwidth of the satellite signal and outside the first bandwidth of the satellite signal; and
select the first code phase to use to determine the position information based on transmission of the outbound signal corresponding to the first time period and to select the third code phase to use to determine the position information otherwise.

5. The apparatus of claim 1, wherein the second bandwidth includes the first bandwidth.

6. A method of measuring a satellite signal, the method comprising:
receiving, at an apparatus, the satellite signal;
determining, at the apparatus, a first code phase of the satellite signal, corresponding to a first time period, based on a first portion of the satellite signal that has a first bandwidth;
determining, at the apparatus, a second code phase of the satellite signal, corresponding to a second time period, based on a second portion of the satellite signal that has a second bandwidth, wherein the second bandwidth is larger than the first bandwidth, and wherein the second time period is separate from the first time period; and
determining, at the apparatus, a cater phase of the satellite signal based on the first portion of the satellite signal and a third portion of the satellite signal that has the first bandwidth and spans the second time period.

7. The method of claim 6, further comprising transmitting, from the apparatus, an outbound signal that induces an interference signal inside the second bandwidth of the satellite signal and outside the first bandwidth of the satellite signal, wherein determining the first code phase comprises determining the first code phase, instead of determining a third code phase, based on transmission of the outbound signal corresponding to the first time period, the third code phase corresponding to the first time period and being based on the second portion of the satellite signal.

8. The method of claim 6, further comprising:
determining a third code phase of the satellite signal, corresponding to the first time period, based on the second portion of the satellite signal; and
selecting one of the first code phase or the third code phase, to use to determine position information, based on expected interference with the second portion of the satellite signal, or based on actual interference with the second portion of the satellite signal, or a combination thereof.

9. The method of claim 8, further comprising:
transmitting, from the apparatus, an outbound signal that induces an interference signal inside the second bandwidth of the satellite signal and outside the first bandwidth of the satellite signal; and
selecting the first code phase to use to determine the position information based on transmission of the outbound signal corresponding to the first time period and selecting the third code phase to use to determine the position information otherwise.

10. The method of claim 6, wherein the second bandwidth includes the first bandwidth.

11. An apparatus comprising:
means for receiving a satellite signal;
means for determining a first code phase of the satellite signal, corresponding to a first time period, based on a first portion of the satellite signal that has a first bandwidth;
means for determining a second code phase of the satellite signal, corresponding to a second time period, based on a second portion of the satellite signal that has a second bandwidth, wherein the second bandwidth is larger than the first bandwidth, and wherein the second time period is separate from the first time period; and
means for determining a carrier phase of the satellite signal based on the first portion of the satellite signal and a third portion of the satellite signal that has the first bandwidth and spans the second time period.

12. The apparatus of claim 11, further comprising means for transmitting an outbound signal that induces an interference signal inside the second bandwidth of the satellite signal and outside the first bandwidth of the satellite signal, wherein the means for determining the first code phase comprise means for determining the first code phase, instead of determining a third code phase, based on transmission of the outbound signal corresponding to the first time period, the third code phase corresponding to the first time period and being based on the second portion of the satellite signal.

13. The apparatus of claim 11, further comprising:
means for determining a third code phase of the satellite signal, corresponding to the first time period, based on the second portion of the satellite signal; and
means for selecting one of the first code phase or the third code phase, to use to determine position information, based on expected interference with the second portion of the satellite signal, or based on actual interference with the second portion of the satellite signal, or a combination thereof.

14. The apparatus of claim 13, further comprising means for transmitting an outbound signal that induces an interference signal inside the second bandwidth of the satellite signal and outside the first bandwidth of the satellite signal, wherein the means for selecting one of the first code phase and the third code phase comprise means for selecting the first code phase, to use to determine the position information, based on transmission of the outbound signal corresponding to the first time period and for selecting the third code phase to use to determine the position information otherwise.

15. The apparatus of claim 11, wherein the second bandwidth includes the first bandwidth.

16. A non-transitory, processor-readable storage medium comprising processor-readable instructions to cause a processor to:
receive a satellite signal;
determine a first code phase of the satellite signal, corresponding to a first time period, based on a first portion of the satellite signal that has a first bandwidth;
determine a second code phase of the satellite signal, corresponding to a second time period, based on a second portion of the satellite signal that has a second bandwidth, wherein the second bandwidth is larger than the first bandwidth, and wherein the second time period is separate from the first time period; and
determine a carrier phase of the satellite signal based on the first portion of the satellite signal and a third portion of the satellite signal that has the first bandwidth and spans the second time period.

17. The storage medium of claim 16, further comprising processor-readable instructions to cause the processor to transmit an outbound signal that induces an interference signal inside the second bandwidth of the satellite signal and outside the first bandwidth of the satellite signal, wherein the processor-readable instructions to cause the processor to determine the first code phase comprise processor-readable instructions to cause the processor to determine the first code phase, instead of determining a third code phase, based on transmission of the outbound signal corresponding to the first time period, the third code phase corresponding to the first time period and being based on the second portion of the satellite signal.

18. The storage medium of claim 16, further comprising processor-readable instructions to cause the processor to:
determine a third code phase of the satellite signal, corresponding to the first time period, based on the second portion of the satellite signal; and
select one of the first code phase or the third code phase, to use to determine position information, based on expected interference with the second portion of the satellite signal, or based on actual interference with the second portion of the satellite signal, or a combination thereof.

19. The storage medium of claim 18, further comprising processor-readable instructions to cause the processor to transmit an outbound signal that induces an interference signal inside the second bandwidth of the satellite signal and outside the first bandwidth of the satellite signal, wherein the processor-readable instructions to cause the processor to select one of the first code phase and the third code phase comprise processor-readable instructions to cause the processor to select the first code phase, to use to determine the position information, based on transmission of the outbound signal corresponding to the first time period and to select the third code phase to use to determine the position information otherwise.

20. The storage medium of claim 16, wherein the second bandwidth includes the first bandwidth.
